(19) United States
(12) Patent Application Publication
(10) Pub. No.: US 2026/0196856 A1
(43) Pub. Date: Jul. 9, 2026

(54) DRONE-BASED DEVICE, METHOD AND SYSTEM FOR CHARGING AND REPLACING BATTERIES OF SMART EQUIPMENT IN THE DISTRIBUTION NETWORK

(71) Applicant: Saudi Electricity Company, Riyadh (SA)

(72) Inventors: Majed Mohammed M. ALSAQRI, Jeddah (SA); Saleh Ali G. SHANNAN, Jeddah (SA); Murad Mebaireik A. ALMAZROUI, Jeddah (SA)

(21) Appl. No.: 19/416,282

(22) Filed: Dec. 11, 2025

(30) Foreign Application Priority Data
Jan. 5, 2025 (SA) 1020250463

(51) Int. Cl. H02J 7/70; B64U 50/39; B64U 60/00; B64U 70/95; B64U 101/26; H01M 50/24; H01M 50/244; H01M 50/251; H01M 50/264; H01M 50/271; H02G 1/02; H02J 7/50; H02J 7/60; H02J 7/64; H02J 13/183; H02J 13/34

(52) U.S. Cl. CPC H02J 7/751; B64U 50/39; B64U 60/00; B64U 70/95; H01M 50/24; H01M 50/244; H01M 50/251; H01M 50/264; H01M 50/271; H02G 1/02; H02J 7/50; H02J 7/64; H02J 7/663; H02J 13/183; H02J 13/34; B64U 2101/26

(57) ABSTRACT

The present disclosure discloses a drone-based device for charging and replacing batteries of smart equipment in the distribution network, wherein the device is in shape of a platform (1) and comprises sequentially arranged incubators, including: at least one electrical feeding incubator (5, 7), configured to receive a drone-transported charged equipment battery (2) and supply a current to the smart equipment via the equipment battery (2); and at least one electric charging incubator (24, 25), configured to charging a drone battery (9).

### FIELD

The present invention relates to an electrical feeder device, which is a landing platform to receive capsule-shaped batteries connect to the smart equipment panels in the distribution network, e.g., auto reclosers, sectionalizers, or ring main units, which are equipment, which usually use batteries to feed special main control panels, the invention also relates to a method and a system for replacing and charging the main feed batteries of that equipment with replacement batteries using a plane without a pilot (drone), instead of using a human element to move to those locations and manually face risks of the replacement process.

### BACKGROUND

Background description includes information that will be useful in understanding the present invention. It is not an admission that any of the information provided herein is prior art or relevant to the presently claimed invention, or that any publication specifically or implicitly referenced is prior art.

The battery platform, for which the cylindrical battery models are standardized, is installed next to each smart equipment and is connected to the main control panel with a specific electrical circuit, wherein the battery platform comprises 6 basic incubators. US. Pat. No. 11,834,181B2 dated Oct. 1, 2020 and US. Pat. No. 9,527,605B1 dated Dec. 27, 2016 disclosed a system for transporting different cargo with different payloads via an automatic dispatch and landing platform based on drones comprising at least one cargo container configured to be automatically dismantled to the aircraft.

The system is specialized in sending cargo and people by using of a medium, which is a specific container inside its wall, wherein there is a battery, which is directly disposed inside, the cargo are disposed inside the container and are transported by depending on drones, wherein this method mainly depends on a container usage to carry cargo, assuming that these cargo are batteries, the process of installing the battery or landing it on the charging platform directly cannot be carried out due to the presence of a container, which is not ready for service as in our invention, also, carrying it by plane and transporting it to an electric charging and discharging receiving platform, which is linked to the equipment of the electricity company is difficult to happen because it requires equipment of a different type, and it is also disadvantaged that it did not include specific parts that make it easy to connect the battery to the plane and thus the difficulty of landing it in the landing platform with details that ensure the speed of service delivery as well as the reliability of having a good electrical contact associated with a safe landing requiring a high fluidity in the design of the battery when it is landed. The system comprises a landing zone based on a positioning system for a landing aircraft, wherein the positioning system comprises at least two moveable positioning elements that connect to the positioning system engine configured to move the two elements.

Also, the invention US. Pat. No. 9,527,605B1 was limited to drone dropping an empty battery and picking up a charged battery on a platform equipped for that, according to what was stated in the detailed description as defined in FIG. 2c, which was an operation not considering letting down or landing system, stability mechanism of batteries, corresponding contact points, identification of charging and discharging locations in the platform, securing the batteries from rainwater and dust, wherein well as the rest of the details provided by the invention.

### SUMMARY

There is provided, according to a first aspect of the present disclosure, a drone-based device for charging and replacing batteries of smart equipment in the distribution network, wherein the device is in the shape of a platform and comprises sequentially arranged incubators, including at least one electrical feeding incubator configured to receive a drone-transported charged equipment battery and supply a current to the smart equipment via the equipment battery, and at least one electric charging incubator configured to charge a drone battery.

Advantageously, the inventors have found that the integrated design of dedicated electrical feeding incubators and drone charging incubators on a single platform eliminates the need for separate equipment for battery replacement and drone recharging, significantly improving the efficiency of on-site operations while reducing the complexity of equipment deployment in distribution network environments.

According to embodiments of the present disclosure, the sequentially arranged incubators further include at least one empty incubator configured to receive a protective cover, wherein the protective cover can be placed in the electrical feeding incubator and/or the electric charging incubator to provide dust and rain protection when the incubators are not in use. Advantageously, an unobstructed battery access can be enabled by temporarily storing protective covers, shielding idle incubators from environmental damage and extending system durability.

According to embodiments of the present disclosure, the at least one electrical feeding incubator includes a main feeding incubator and a replacement feeding incubator, wherein the main feeding incubator serves as the default feeding incubator to receive the charged equipment battery, while the replacement feeding incubator acts as a backup to ensure continuous power supply to the smart equipment during battery replacement or maintenance. Advantageously a redundant power supply can be provided via main and backup incubators, ensuring uninterrupted operation of smart equipment during battery replacement.

According to embodiments of the present disclosure, each of the electrical feeding incubators is provided with one electrical switch, wherein each electrical switch is connected via an electrical circuit for realizing electrical current switching between the electrical feeding incubators; when the equipment battery lands in one of the electrical feeding incubators, the bottom of the equipment battery presses a button of the corresponding electrical switch to cut off the electric current from the other incubator, thereby preventing the electrical voltage of the smart equipment from exceeding the allowable limit and ensuring operational safety. Advantageously, current can be automatically switched between incubators via battery weight-triggered switches, preventing overvoltage and ensuring safe, seamless power transition.

According to embodiments of the present disclosure, the platform further includes an electrical output connected to a cable, wherein at least a first terminal of the cable is allocated for supplying electrical energy to the electric charging incubator by drawing power from the electrical grid, while at least a second terminal is designated for transmitting electrical energy from the electrical feeding incubator to the smart equipment, enabling dual-purpose power transmission through a single cable connection. Advantageously, wiring with dual-terminal cables can be simplified, enabling independent and reliable power supply for drone charging and smart equipment feeding.

According to embodiments of the present disclosure, the drone is equipped with the drone battery for its own power supply, wherein the drone battery is connected to the drone via a threaded helical screw to realize stabilization, and no disassembly or removal is required when the drone battery is charged, simplifying the charging process and reducing operational downtime. Advantageously, the possibility of battery disassembly can be eliminated during charging, shortening drone downtime and ensuring secure battery fixation during flight.

According to embodiments of the present disclosure, a fluke is provided under the equipment battery, and a hook is provided on the protective cover for protecting the electrical feeding incubator or electric charging incubator from rain and dust; the fluke under the equipment battery can be attached to the hook to transfer the protective cover to the empty incubator, preparing the electrical feeding incubator or the electric charging incubator to receive the equipment battery or the drone battery without manual intervention.

According to embodiments of the present disclosure, the contact terminals in the electrical feeding incubator and the contact terminals in the electric charging incubator are shaped as opposing brackets, which are configured to evenly distribute the load of the batteries and enhance mechanical stability during charging or power supply, avoiding poor contact caused by uneven stress.

According to embodiments of the present disclosure, the drone is equipped with a 180° rotatable thermal camera, omnidirectional under-view cameras, and adjustable lighting lamps; the thermal camera is configured to inspect electrical grid lines, record temperatures, and detect potential malfunctions during the drone's outbound and return flights, enabling simultaneous completion of battery-related tasks and grid inspection to improve overall maintenance efficiency.

According to embodiments of the present disclosure, the equipment battery is detachably connected to the drone via a shaft disposed on the battery, a shaft slot on the shaft, an electrically controlled fixing key, an electric coil, and a spring; the fixing key is pushed by the spring to insert into the shaft slot for locking the equipment battery during transport, and the electric coil generates magnetic force to retract the fixing key when the battery lands, enabling the equipment battery to be released into the corresponding incubator accurately and reliably.

According to embodiments of the present disclosure, laser lights are mounted on both sides of the drone, and the platform is provided with X-shaped centering points; the laser lights are activated during battery landing, and their light beams are aligned with the centering points to precisely position the battery landing position, ensuring that the battery is placed in the incubator with high accuracy even in complex environmental conditions.

According to embodiments of the present disclosure, rubber sealing rings are arranged under the base of each incubator to prevent water and dust from entering the incubators, and the protective covers are configured to shield the electrical feeding incubators and electric charging incubators from rain and dust when not in use, extending the service life of the batteries and the platform in outdoor environments.

According to embodiments of the present disclosure, the platform is installed in one of two ways: either on an independent U-shaped shaft fixed to the ground near the electrical grid shaft via bearings, or on an L-shaped shaft directly connected to the electrical grid shaft, providing flexible installation options to adapt to different spatial layouts of distribution network equipment.

According to embodiments of the present disclosure, the equipment battery is cylindrical in shape, and its own weight enhances the tightness of electrical contact between the battery's connection terminals and the incubator's contact terminals, preventing sudden voltage fluctuations caused by loose contact and ensuring stable power supply to the smart equipment.

According to embodiments of the present disclosure, the platform is fabricated from metal-reinforced fiber material, which provides structural rigidity to withstand drone landing impacts while maintaining a lightweight profile, facilitating easy installation and maintenance of the platform in remote or high-altitude distribution network locations.

According to embodiments of the present disclosure, the protective cover has a half-egg-shaped weight, which facilitates stable placement in the empty incubator and ensures secure attachment to the hook during transfer, preventing the protective cover from falling or shifting during drone operation and ensuring the reliability of the dust and rain protection function.

There is provided, according to a second aspect of the present disclosure, a method for charging and replacing batteries of smart equipment in a distribution network using a drone-based platform, the method comprising: transporting a charged equipment battery to at least one electrical feeding incubator of the platform via a drone; supplying an electric current to the smart equipment through the equipment battery received in the electrical feeding incubator; and charging a drone battery of the drone via at least one electric charging incubator of the platform.

The method further optionally includes transferring a protective cover to an empty incubator of the platform, realizing automatic current switching between incubators, and inspecting electrical grid lines via a drone-mounted thermal camera during flight.

There is provided, according to a third aspect of the present disclosure a system for charging and replacing batteries of smart equipment in the distribution network by drones, the system comprising: a drone equipped with an equipment battery for supplying power to the smart equipment and/or a drone battery for its own operation; and a receiving platform, which is configured to cooperate with the drone to complete battery replacement, charging, and protective cover storage, the platform being installable in a flexible manner to adapt to different distribution network environments.

According to embodiments of the present disclosure, the drone is further configured with components such as laser lights for positioning, a thermal camera for grid inspection, and an electrically controlled fixing mechanism for battery locking and release.

There is provided, according to a further aspect of the present disclosure, a device for charging and replacing batteries of smart equipment in the distribution network by drones, wherein the device comes in a platform shape operating to receive and replace batteries for electrical equipment of all types and shapes of equipment distributed in all regions, wherein the device unifies all batteries for electrical equipment, speeds up the process of transporting them, and facilitates the process of replacing defective ones according to the highest standards that increase reliability according to claim, the parts of the device comprise:
a rectangular-shaped electric feeding device made of metal-reinforced fibre, with six incubators designated to receive, replace and charge cylindrical batteries that can include all items in all their forms, and the feeding device is a platform divided into two opposite parts, a part has three incubators designated for charging and a part has three incubators designated for feeding electrical equipment, and the number of them can be increased according to the need, and the platform has a number of incubators that can be arranged sequentially according to the following:
   a) Incubators designated for main electrical feeding and replacement electrical feeding can do the same work, they are incubators, which are in one direction, and their task is to receive the charged batteries transferred by drones, and they are designated for feeding the electrical equipment with electric current operating according to an alternating method by means of electrical switches, wherein the main feeding incubator is the incubator first receiving the battery, therefore called the main incubator and the other is the replacement incubator;
   b) Incubators designated for electric charging and, which are in the opposite direction to the main and replacement feeding incubators, whose task is only to charge the drone batteries;
   c) Empty incubators made of plastic or fiber, which are incubators located in the middle, their task is to receive the protective covers, which are covers that end in a weight in the shape of half an egg, when the plane needs to be charged or a disabled battery is replaced, the protective covers are present in the replacement feeding incubators and cargo incubators to protect it from rain and dust, and it is necessary to move them from them depending on the movement of the aircraft, wherein the fluke located under the main battery is attached to the hook above the cover and then it is transferred to empty incubators to equip the replacement feeding incubator or charge to receive batteries.

There is provided, according to a further aspect of the present disclosure, a system for charging and replacing batteries of smart equipment in the distribution network by drones comprises:
a) a drone at the bottom of which is installed cylindrical batteries, which are at least two batteries configured to be automatically and/or manually removable and can be remotely directed or automatically through prior programming;
b) receiving platform for drone, the receiving platform comprises:
   A high letting down zone, which can be accessible by drone from the air, and the landing zone rests on an independent shaft, which supports the platform, with a height of no more than 5 meters from the ground, so that the person present can use a ladder to reach it, or the platform can be based on a shaft, which is in the shape of the Latin letter L that is directly connected to the shaft of the electrical grid,
   wherein the letting down platform comprises main feeding incubators and replacement, which are one-direction incubators, their task is to receive charged batteries carried by aircraft, and is designated for feeding electrical equipment with electric current, which works according to a special exchange method, wherein well as contains charging incubators and, which are incubators, which are in the opposite direction to the main and replacement feeding incubators, whose task is only to charge the batteries of drones, and also contains empty incubators, which are incubators located in When the aircraft needs to be charged or a faulty battery replaced, the protective covers are located in the replacement feeding incubators and charging incubators to protect it from rain and dust, and it is necessary to move them depending aircraft movement, wherein the fluke under the main battery is attached to the cover hook, then transferred to the empty incubators to prepare the replacement feeding or charging incubator to receive the batteries.

It will be appreciated that features disclosed in relation to one aspect of the present disclosure may be applicable to other aspects of the present disclosure, and vice versa.

### BRIEF DESCRIPTION OF THE DRAWINGS

The manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of the present disclosure and are therefore not to be considered limiting of its scope, for the present disclosure may admit to other equally effective embodiments.

FIG. 1 shows a drone at the moment the battery is landed onto the platform and shows the details of the front incubators for a main, replace, and reserve feeder as well as an aircraft front.

FIG. 2 shows a lateral perspective of the drone carrying its battery and the replacement battery, wherein well as showing how to connect with it, the primary battery charging terminals, wherein well as how to connect, the location of the replacement battery charging terminals, and the location of the cameras.

FIG. 3 shows details of platform parts, the position of the incubators for main, replace, and reserve feeding, and the micro switch.

FIG. 4 shows an upper view showing platform shape with details of the incubators and the position of the contact terminals.

FIG. 5 shows examples of platform locations at electrical grid equipment showing how it connects with it and the platform is in use, and the main power battery is also shown on the platform in its normal position as well as the covers in their positions.

FIG. 6 shows drone's launch path over electrical grid lines as it transfers the battery remotely from the service center to electrical equipment, e.g., to loop feeders, wherein well as to repeaters.

The foregoing and other objects, features and advantages of the present invention, as well as the invention itself, will be more fully understood from the following description of preferred embodiments, when read together with the accompanying drawings.

### DETAILED DESCRIPTION

The present disclosure relates to the field of electrical feeding devices for smart equipment in the distribution network, which is a landing platform configured to receive capsule-shaped batteries connected to the main control panels of such equipment (e.g., auto reclosers, sectionalizers, ring main units), and more particularly to a device, method, and system for remotely charging and replacing the main feed batteries of said smart equipment using unpiloted aerial vehicles (drones), realizing safe, efficient battery transfer, stable electrical contact, and automated switching between batteries without manual intervention.

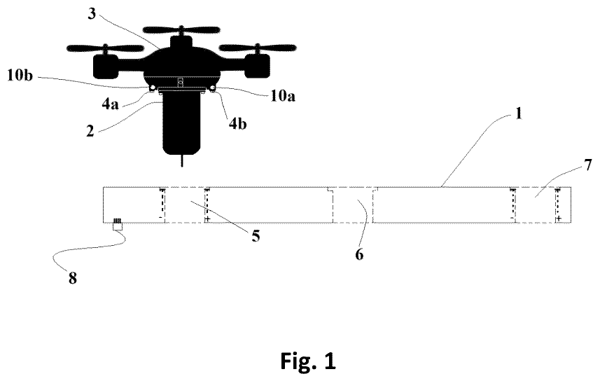

The principles of the present invention and their advantages are best understood by referring to FIG. 1 to FIG. 6. In the following detailed description of illustrative or exemplary embodiments of the disclosure, specific embodiments in which the disclosure may be practiced are described in sufficient detail to enable those skilled in the art to practice the disclosed embodiments. The following detailed description is, therefore, not to be taken in a limiting sense, and the scope of the present disclosure is defined by the appended claims and equivalents thereof. References within the specification to “one embodiment,” “an embodiment,” “embodiments,” or “one or more embodiments” are intended to indicate that a particular feature, structure, or characteristic described in connection with the embodiment is included in at least one embodiment of the present disclosure.

FIG. 1 shows drone components 3 and an electricity feeder device configured to receive, replace and charge batteries in the areas of electrical equipment operation that work according to a specific system, and the device is a platform 1 charging and a rectangle-shaped electric feeding, in the normal situation there is a main feeding battery 2, which is also known as the equipment battery and transported by the drone to the platform and remains connected to the electrical equipment to ensure the supply of electricity to it for a long time, and the platform has a number of incubators that can be arranged sequentially according to the following:
Main feeding incubators 5 and replacement feeding incubators 7, which are one-way incubators, and their task is to receive charged batteries carried by the drone, and are specific to feeding electrical equipment with electric current, which works according to a special exchange method.
Cargo incubators 24 and 25, which are electric charging incubators that are in the opposite direction to the main and replacement feeding incubators, whose task is only to charge the drone batteries.
Empty incubators 6, which are incubators located in the middle and their task is to receive the protective covers, when the drone needs to be charged or replaced with a broken battery, the protective covers are present in the replacement feeding incubators and cargo incubators to protect it from rain and dust, and it is necessary to move them depending on the movement of the drone, wherein the fluke under the main battery is attached to the cover hook, then it is transferred to the empty incubators to prepare the replacement feeding or charging incubator to receive the batteries.

The platform further comprises an electrical output 8 connected to a four-terminal cable, wherein both terminals 14a are allocated for the electrical feeding of the charging incubators and the electrical energy is supplied to them from the electrical grid current, and the other two 14b terminals are specific to transmitting electrical energy from the main or replacement feed batteries to the electrical equipment.

The platform further comprises, in the feeding incubators or charging incubators the terminals of contacts 17a/17b and 32a/32b in the shape of opposite brackets in order to distribute the battery load evenly on them and also for more stability, and in the main and replacement incubator there are two switches 34, which have three terminals 36, the switches are connected through an electrical circuit operating to achieve electrical rotation between them, in other words, when an replacement battery is disposed in its incubator, it is once landed. The battery in the replacement incubator will press the button 35 of the switch to unplug the electric current from the main feeding incubator and vice versa, thus allowing the electric current to pass from the replacement incubator to the electrical equipment ensuring the electrical voltage of the equipment does not exceed the allowed voltage.

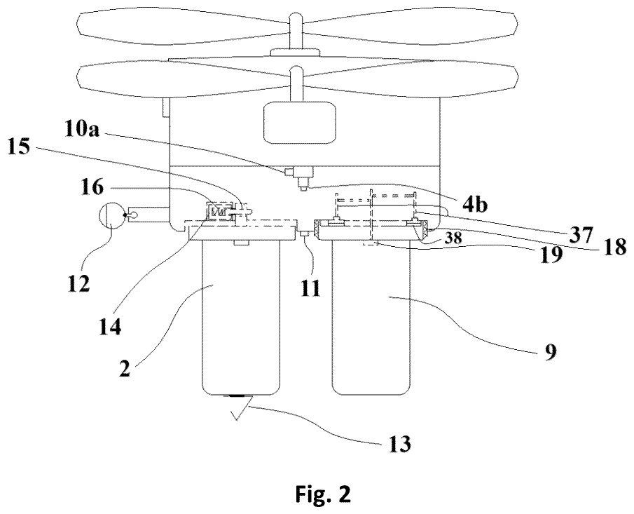

FIG. 2 presents a lateral perspective of the drone 3 carrying two essential batteries: its own drone battery 9 and the equipment battery 2. It explicitly illustrates the mechanical and electrical connection mechanisms between the drone and the batteries, as well as the spatial arrangement of key components.

The drone is equipped with a thermal camera 12, which is moveable at an angle of 180 degrees, wherein well as there are under-view cameras 11 and lighting lamps 10a/10b, which is moveable in all directions, and the drone comprises its own battery 9, which is connected to the drone by a spiral screw 18, which stabilizes it permanently, wherein it does not need to be dismantled or removed when charging.

The bottom of the drone further comprises a removable battery 2, which is pre-charged with electricity, which is installed on the drone manually or automatically by landing the lower space of the drone until it collides with the shaft 30 above the battery, so that the shaft slot 29 meets the fixing key 15 which moves electrically according to the magnetic attraction forces by an electric coil 14, which is remotely controlled, in the case of battery lock, the key is pushed by the spring force 16, and enters the shaft slot and prevents the battery. When the battery is landed on the platform, the coil is fed with electric current, and gravitational forces are generated attracting the key, thus, the battery is released.

There are also laser lights 4a/4b on both sides of the drone, which are activated when the batteries are landed, wherein their lighting is balanced until they correspond to centering points 26 on the platform, thus accurately determine the correct landing position.

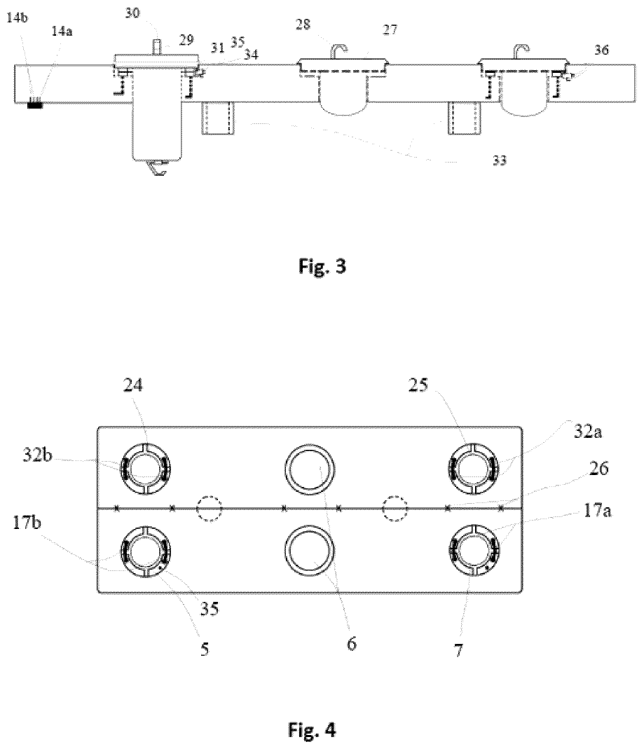

FIG. 3 focuses on the structural details of the landing platform 1, emphasizing incubator configuration and the key electrical switching mechanism. It identifies the positions of the main feeding incubator 5, replacement feeding incubator 7, empty incubator 6, and electric charging incubators 24, 25. The main and replacement feeding incubators are unidirectional, dedicated to supplying power to smart equipment, while the centrally located empty incubator stores the protective cover 27 during battery transfer.

The protective cover 27 can be dismantled from the replacement or main feeding incubators when starting to unload the batteries by moving the drone until the fluke 13 corresponds to the hook 28 of the cover, and when it is attached to it, it is lifted and directed to the empty incubators 6 and then released by landing the drone slightly and then returning to the required incubator.

Also, the battery 9 of the drone can be charged after it is landed, so that if we assume that the drone will land in the incubator 25, the contacts 32A will connect to the charging points 19 of the battery, wherein the electric current will go from the wires 37 to the terminals of the battery 38 until the charging is complete.

The platform 1 is installed either on an independent shaft 23 near the electric grid shaft 20 by inserting the bearings 33 connected to the platform in the sand in the shape of the Latin letter U, which is connected to the independent shaft whose terminal is fixed in the ground, or the platform is installed on a shaft 39 in the shape of the Latin letter L, which is directly connected to the shaft of the electrical grid 20, and the platform is connected to the electrical grid equipment e.g., to the box of the repeater 21 by means of an electric wire 22, which supplies the platform with electricity in cases of electric charging as well as connects to the power input of the power repeater to feed it with the main electricity.

The system sequence can be explained in the cases that require charging or replacing the batteries of smart equipment in the distribution network using drones according to the following:

In case of a technical failure of the main battery of the equipment, a fully charged replacement battery is installed in the drone either manually or by picking it up from a platform equipped with batteries, then the guidance of the drone is remotely controlled until it reaches the location of the broken battery, in the normal situation, the electrical equipment has a main feed battery that is usually installed either in the main feeding incubator or the replacement incubator, which in this case is malfunctioning and must be replaced urgently, wherein it starts. The drone is in the process of replacement—assuming the main feeder battery is in incubator 5—wherein the following steps should be taken:
I. The drone will immediately head to an replacement incubator 7, then operation will start by landing the drone to prepare the incubator by removing the protective cover 27 until the fluke 13 corresponds to the hook 28, when being attached, it is lifted and moved upwards and directed to one of the empty incubators 6, then landed upon landing the drone slightly until released in the said incubator wherein the pickup or landing is directed by depending on laser lights 4a/4b, they are aimed, When landing the batteries, so that their lighting is balanced to correspond to the positioning points 26 in the shape of the Latin letter X on the platform, thus accurately determine the letting down position and landing.
II. The drone will proceed to land the battery 2 in the replacement incubator 7, in this case, the laser lights 4a/4b are used by aiming them when landing the batteries, so that their lighting is balanced until they correspond to the positioning points 26 in the shape of the Latin letter x on the platform, and thus the correct landing position is precisely determined and the landing is done.
III. The replacement battery is dismantled from the drone by cutting off the current from the electrical coil 14, thus, the key is withdrawn 15, and the spring 16 is compressed, thus, the key is released from the opening 29 in the shaft 30 and this allows the battery to descend and settle in the incubator, and at the moment of landing the battery on the platform, the button 35 of the switch 34 will be pressed under the battery to unplug the electric current from the incubator 5 and direct the path to the incubator 7, thus allowing the electric current to pass from the incubator Replacement and then to the electrical equipment ensuring the electrical voltage of the equipment does not exceed the allowable voltage.
IV. Meanwhile, the drone battery 9 will land in the charging incubator 25 and the charging points 19 of the battery will be meet the contacts 32a to start the charging process of the drone battery.
V. After the drone is finished charging, it will rise to the top and then go to the incubator 5 to pick up the damaged battery by using laser lights 4a/4b by aiming it and then landing the drone, so that its lighting is balanced until it corresponds to the positioning points 26 in the shape of the Latin letter x on the platform, and thus the correct landing position is accurately determined and the landing is done, then the landing is done gradually until the battery incubator in the drone collides with the shaft 30 located above The battery so that the shaft slot 29 meets the fixing key 15 which moves electrically according to the magnetic attraction forces by the action of an electric coil 14 which is remotely controlled, in this case the electrical supply will be stopped from the electrical coil meanwhile the key 15 will be pushed by the spring force 16 and enter the shaft slot and hold the battery, then the return trip will be made again to the starting center to detect, repair and put the damaged battery into service again.
VI. During the outbound flight of the drone to provide the service as well as during the return flight, the drone will take a programmed route, wherein the drone will travel over the lines of the electrical grid to carry out the tasks of checking the lines through the thermal camera 12, recording all the observations in the memory unit, and the geographical location data of the affected case, if any, will be recorded.
VII. As a replacement option for system operation, the drone can be flown completely autonomously or semi-autonomously, wherein the drone can be programmed by computer and will find its way through specific positioning systems and/or avoid obstacles through a specific sensor system.

FIG. 4 presents a top view of the rectangular landing platform 1, highlighting incubator layout and contact terminal design. The top view clarifies the sequential arrangement of incubators 5, 6, 7, 24, 25 across the platform surface, ensuring a logical flow for battery replacement and charging. The empty incubator 6 is positioned in the middle to facilitate efficient transfer of the protective cover 27 between feeding and charging incubators.

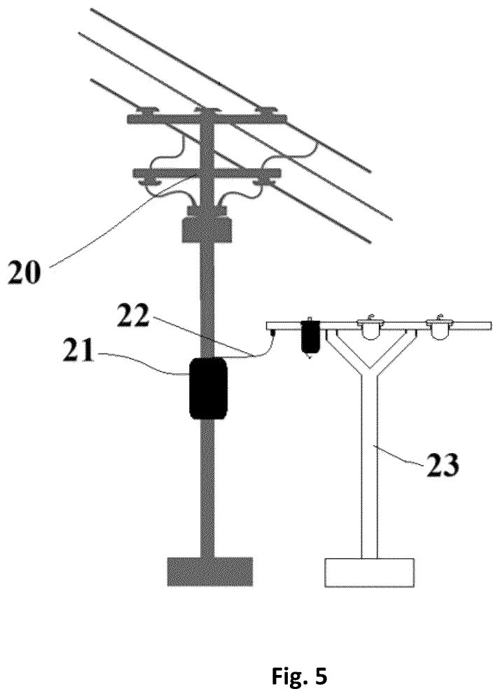

FIG. 5 demonstrates the practical installation scenarios of the landing platform 1 in association with electrical grid equipment, as well as its operational state during normal use. The platform offers two installation configurations. A configuration involves mounting it on an independent U-shaped shaft 23 near the electrical grid shaft 20, with the shaft's terminal fixed to the ground for stability.

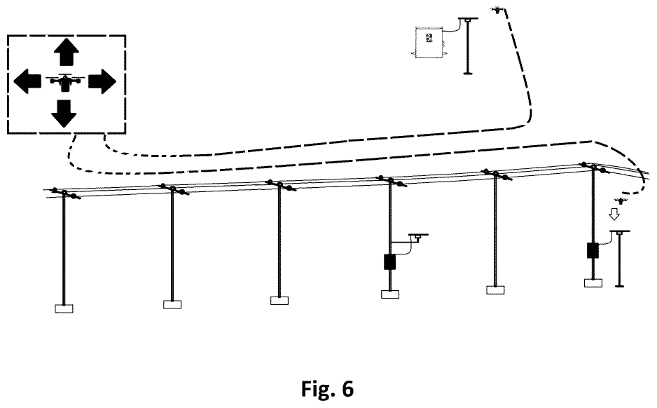

FIG. 6 illustrates the drone's launch path, flight trajectory, and mission scope for remote battery transport and grid inspection. The drone departs from a service center and flies along a pre-programmed path over electrical grid lines. It transports the charged replacement battery 2 to target smart equipment and returns with the damaged or depleted equipment battery 2 after replacement.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents. The disclosures and the description herein are intended to be illustrative and are not in any sense limiting the present disclosure, defined in scope by the following claims.

Many changes, modifications, variations and other uses and applications of the present disclosure will become apparent to those skilled in the art after considering this specification and the accompanying drawings, which disclose the preferred embodiments thereof. All such changes, modifications, variations and other uses and applications, which do not depart from the spirit and scope of the present disclosure, are deemed to be covered by the invention, which is to be limited only by the claims which follow.

1. A drone-based device for charging and replacing batteries of smart equipment in the distribution network, wherein the device is in shape of a platform (1) and comprises sequentially arranged incubators, including:
at least one electrical feeding incubator (5, 7), configured to receive a drone-transported charged equipment battery (2) and supply a current to the smart equipment via the equipment battery (2); and
at least one electric charging incubator (24, 25), configured to charging a drone battery (9).

2. The device according to claim 1, wherein the sequentially arranged incubators further include at least one empty incubator (6), which is configured to receive a protective cover (27), wherein the protective cover (27) can be placed in the electrical feeding incubator (5, 7) and/or the electric charging incubator (24, 25).

3. The device according to claim 1, wherein the at least one electrical feeding incubator (5, 7) includes a main feeding incubator (5) and a replacement feeding incubator (7), wherein the main feeding incubator (5) serves as the default feeding incubator to receive the charged equipment battery (2), while the replacement feeding incubator (7) acts as a backup.

4. The device according to claim 3, wherein each of the electrical feeding incubators (5, 7) is provided with one electrical switch (34), wherein each of the electrical switches (34) is connected via an electrical circuit for realizing electrical current switching between the electrical feeding incubators (5, 7), wherein the bottom of the equipment battery (2) presses a button (35) of the corresponding electrical switch (34) to cut off the electric current from the other incubator (7, 5) when the equipment battery (2) lands in one of the electrical feeding incubators (5, 7), thereby preventing the electrical voltage of the smart equipment from exceeding the allowable limit.

5. The device according to claim 1, wherein the platform (1) further includes an electrical output (8) connected to a cable, wherein at least a first terminal (14a) of the cable is allocated for supplying electrical energy to the electric charging incubator (24, 25) and draw power from the electrical grid, while at least a second terminal (14b) is designated for transmitting electrical energy from the electrical feeding incubator (5, 7) to the smart equipment.

6. The device according to claim 1, wherein the drone is equipped with the drone battery (9) for its own power supply, wherein the drone battery (9) is connected to the drone via a threaded helical screw (18) to realize stabilization, and no disassembly or removal is required when the drone battery (9) is charged.

7. The device according to claim 1, wherein a fluke (13) is provided under the equipment battery (2), and a hook (28) is provided on the protective cover (27) for protecting the electrical feeding incubator (5, 7) or electric charging incubator (24, 25) from rain and dust, wherein the fluke under the equipment battery (2) is attached to the hook (28), then the protective cover (27) can be transferred to the empty incubator to prepare the electrical feeding incubator (5, 7) or the electric charging incubator (24, 25) to receive the equipment batterie or the drone batterie.

8. The device according to claim 1, wherein the contact terminals (17a/17b) in the electrical feeding incubator (5, 7) and the contact terminals (32a/32b) in the electric charging incubator (24, 25) are shaped as opposing brackets, configured to evenly distribute the load of the batteries and enhance mechanical stability during charging or power supply.

9. The device according to claim 1, wherein the drone is equipped with a 180° rotatable thermal camera (12), omnidirectional under-view cameras (11), and adjustable lighting lamps (10a/10b), wherein the thermal camera (12) is configured to inspect electrical grid lines, record temperatures, and detect potential malfunctions during the drone's outbound and return flights.

10. The device according to claim 1, wherein the equipment battery (2) is detachably connected to the drone via a shaft (30) disposed on the battery, a shaft slot (29) on the shaft (30), an electrically controlled fixing key (15), an electric coil (14), and a spring (16), wherein the fixing key (15) is pushed by the spring (16) to insert into the shaft slot (29) for locking the equipment battery (2) during transport, and the electric coil (14) generates magnetic force to retract the fixing key (15) when the battery lands, enabling the equipment battery (2) to be released into the corresponding incubator.

11. The device according to claim 1, wherein laser lights (4a/4b) are mounted on both sides of the drone, and the platform (1) is provided with X-shaped centering points (26); the laser lights (4a/4b) are activated during battery landing, and their light beams are aligned with the centering points (26) to precisely position the battery landing position.

12. The device according to claim 1, wherein rubber sealing rings are arranged under the base of each incubator (5, 7; 6; 24, 25) to prevent water and dust from entering the incubators, and the protective covers (27) are configured to shield the electrical feeding incubators (5, 7) and electric charging incubators (24, 25) from rain and dust when not in use.

13. The device according to claim 1, wherein the platform (1) is installed in one of two ways:
either on an independent U-shaped shaft (23) fixed to the ground near the electrical grid shaft (20) via bearings (33), or on an L-shaped shaft (39) directly connected to the electrical grid shaft (20).

14. The device according to claim 1, wherein the equipment battery (2) is cylindrical in shape, and its own weight enhances the tightness of electrical contact between the battery's connection terminals and the incubator's contact terminals, preventing sudden voltage fluctuations.

15. The device according to claim 1, wherein the platform (1) is fabricated from metal-reinforced fiber material, providing structural rigidity to withstand drone landing impacts while maintaining a lightweight profile for easy installation and maintenance.

16. The device according to claim 2, wherein the protective cover (27) has a half-egg-shaped weight, facilitating stable placement in the empty incubator (6) and ensuring secure attachment to the hook (28) during transfer.

17. A method for charging and replacing batteries of smart equipment in a distribution network using a drone-based platform, comprising:
a) Transporting a charged equipment battery to at least one electrical feeding incubator of the platform via a drone;
b) Supplying an electric current to the smart equipment through the equipment battery received in the electrical feeding incubator;
c) Charging a drone battery of the drone via at least one electric charging incubator of the platform.

18. The method according to claim 17, further comprising:
Placing a protective cover in at least one empty incubator of the platform;
Transferring the protective cover to the electrical feeding incubator and/or the electric charging incubator.

19. The method according to claim 17, wherein step a) comprises:
Prioritizing transporting the charged equipment battery to a main feeding incubator to serve as a default feeding incubator for the smart equipment.

20. The method according to claim 19, further comprising:
Pressing a button of a corresponding electrical switch via the self-weight of the equipment battery when the charged equipment battery lands in one of the electrical feeding incubators;
Cutting off the electric current from the other electrical feeding incubator through the electrical switch, which is connected to the other incubator via an electrical circuit, to prevent the voltage of the smart equipment from exceeding an allowable limit.

21. The method according to claim 17, further comprising:
Drawing electrical energy from an electrical grid via at least a first terminal of a cable connected to an electrical output of the platform, and supplying the electrical energy to the electric charging incubator;
Transmitting electrical energy from the electrical feeding incubator to the smart equipment via at least a second terminal of the cable.

22. The method according to claim 17, wherein step c) comprises:
c1) Stabilizing the drone battery on the drone via a threaded helical screw;
c2) Charging the drone battery through the electric charging incubator without disassembling or removing the drone battery from the drone.

23. The method according to claim 17, wherein a fluke is provided under the equipment battery( and a hook is provided on the protective cover for protecting the electrical feeding incubator or electric charging incubator from rain and dust, wherein the fluke under the equipment battery is attached to the hook, then it can be transferred to the empty incubator to prepare the electrical feeding incubator or the electric charging incubator to receive the equipment batterie.

24. The method according to claim 17, wherein in steps b) and c):
the equipment battery and the drone battery are brought into contact with contact terminals of the electrical feeding incubator and the electric charging incubator respectively, wherein the contact terminals are shaped as opposing brackets to evenly distribute the load of the batteries and enhance mechanical stability during charging or power supply.

25. The method according to claim 17, further comprising:
Activating a 180° rotatable thermal camera, omnidirectional under-view cameras, and adjustable lighting lamps mounted on the drone during the drone's outbound and return flights;
Inspecting electrical grid lines, recording temperatures, and detecting potential malfunctions via the thermal camera.

26. The method according to claim 17, wherein step a) comprises:
a3) Locking the equipment battery to the drone during transport by pushing an electrically controlled fixing key into a shaft slot, which is provided on a shaft of the equipment battery, via a spring;
a4) Generating magnetic force via an electric coil when the equipment battery lands, retracting the fixing key, and releasing the equipment battery into the corresponding electrical feeding incubator.

27. The method according to claim 17, wherein in steps a) and c):
Activating laser lights mounted on both sides of the drone when the equipment battery and/or drone battery lands;
Aligning light beams of the laser lights with X-shaped centering points provided on the platform to precisely position the battery landing position.

28. The method according to claim 17, further comprising:
Preventing water and dust from entering the electrical feeding incubator and/or the empty incubator and/or the electric charging incubator via rubber sealing rings arranged under the base of each incubator;
Shielding the electrical feeding incubator and electric charging incubator from rain and dust with the protective cover when they are not in use.

29. The method according to claim 17, further comprising one of the following steps:
Mounting the platform on an independent U-shaped shaft fixed to the ground near an electrical grid shaft via bearings; or
Mounting the platform on an L-shaped shaft directly connected to the electrical grid shaft.

30. The method according to claim 17, wherein step b) comprises:
Enhancing the tightness of electrical contact between connection terminals of the cylindrical equipment battery and contact terminals of the electrical feeding incubator via the self-weight of the equipment battery, so as to prevent sudden voltage fluctuations.

31. The method according to claim 17, wherein the platform is fabricated from a metal-reinforced fiber material to provide structural rigidity for withstanding drone landing impacts while maintaining a lightweight profile for easy installation and maintenance.

32. The method according to claim 18, wherein the protective cover is stably placed in the empty incubator and securely attached to the hook during transfer via a half-egg-shaped weight provided at an end of the protective cover.

33. A system for charging and replacing batteries of smart equipment in the distribution network by drones, comprising:
a drone (3), equipped with an equipment battery (2) and/or a drone battery (9); and
a receiving platform (1) according to claim 1.
